(19) United States
(12) Patent Application Publication
(10) Pub. No.: US 2007/0150219 A1
(43) Pub. Date: Jun. 28, 2007

(54) Method of validating and applying radio frequency tags to an object

(76) Inventors: Gordon M. Cawker, Federal Way, WA (US); Barbara J. McCann, Federal Way, WA (US); Thomas A. Schmitt, Lakewood, WA (US)

Correspondence Address: WEYERHAEUSER COMPANY;INTELLECTUAL PROPERTY DEPT., CH 1J27, P.O. BOX 9777, FEDERAL WAY, WA, 98063, US

(21) Appl. No.: 11/317,437

(22) Filed: Dec. 22, 2005

(51) Int. Cl. G01N 37/00; G08B 13/14

(52) U.S. Cl. 702/82; 340/572.1

(57) ABSTRACT

In an assembly line (22) of the type having a conveyor for moving an object (24) along a predetermined path, a method of applying an identification tag (46) to the object is provided. The method includes using a conveyor for automatically advancing the object along the predetermined path, and supplying a plurality of identification tags. The method also includes testing the plurality of identification tags to identify at least one operating identification tag, and applying at least one operating identification tag on the object while the object is on the conveyor.

### TECHNOLOGY FIELD

The present disclosure relates generally to radio frequency identification tags and, more particularly, to a method of applying such tags to an object.

### BACKGROUND

Radio frequency identification (RFID) tags are tags with integrated circuits that may be attached to containers, packages, or individual goods. They are used to store information about the item, such as price, serial number, and shipping information (including tracking number, shipping date, arrival date, as well as other information). RFID tags generally include an RFID signal transmitter which generates a radio frequency signal. In general, the RFID tag detects a reader interrogation signal and replies by transmitting a response signal that contains the information stored in the RFID tag. The reader detects the response signal from the RFID signal transmitter and stores the information in its memory. Some RFID tags contain a battery, while others convert the energy of received interrogation signals and use that energy to power their circuits.

Some vendors require that RFID tags be applied to shipping containers and boxes. Such vendors also require that the RFID tags be placed within a prescribed location on the box and be operational at a minimum cost. Not only must the RFID tags be located substantially within a prescribed location, but they also must satisfy performance parameters. Thus, there exists a need for a method of validating and applying identification tags to an object that reliability locates such a tag on the object and increases the chance that an operational tag is placed on the object.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A method of applying an identification tag to an object is provided. Such a method is suitable for multiple applications, including in an assembly line of the type that includes a conveyor for moving an object along a predetermined path. An embodiment of applying an identification tag to the object includes using the conveyor for automatically advancing the object along the predetermined path and supplying a plurality of identification tags. The method also includes testing the plurality of identification tags to identify at least one operating identification tag and applying at least one operating identification tag on the object while the object is on the conveyor.

### DESCRIPTION OF THE DRAWINGS

The foregoing aspects and many of the attendant advantages of this disclosure will become better understood by reference to the following detailed description, when taken in conjunction with the accompanying drawings, wherein:

FIG. 1 is a diagrammatical view of one example of a system using a method of applying identification tags to an object according to one embodiment of the present disclosure;

FIG. 2 is a flow diagram of a validation aspect according to one embodiment of the present disclosure and showing a visual inspection component;

FIG. 3 is a flow diagram of a method of applying identification tags to an object; and

FIG. 4 is a diagrammatical view of a second non-limiting example of a system using a method of applying identification tags to an object according to a second embodiment of the present disclosure.

### DETAILED DESCRIPTION

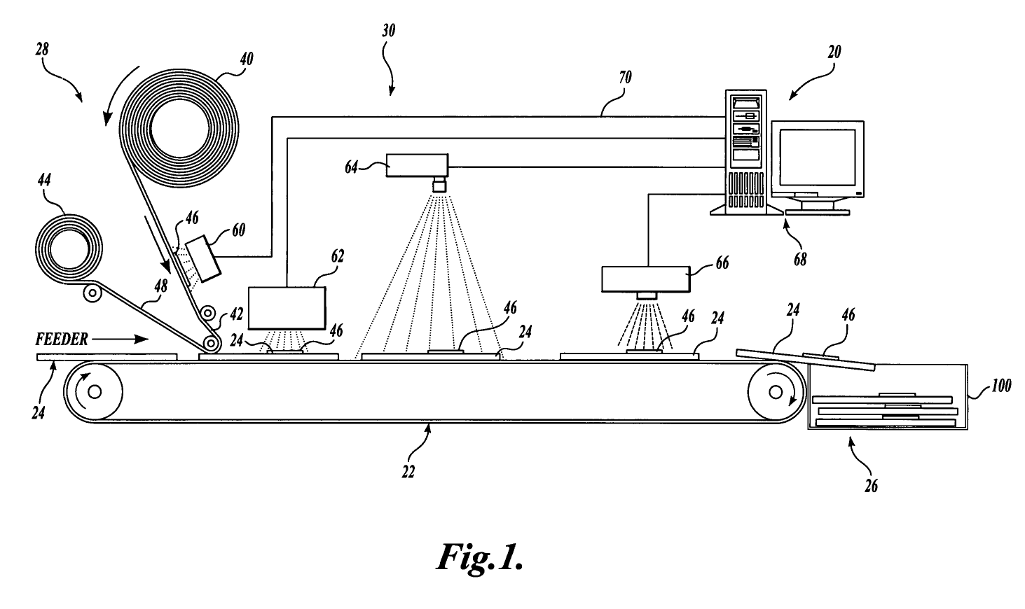

FIG. 1 diagrammatically depicts a system 20 for implementing a method of applying an identification tag to an object in accordance with one embodiment of the present disclosure. The system 20 is a suitable automated or semi-automated manufacturing line having a transport assembly 22 for moving an object 24 along a predetermined path defined between a feeder area (not shown) and a collection station 26.

As a non-limiting example, such a system is illustrated and described below as one used to manufacture cardboard container flats. In such an example, sheets of corrugated paper are fed into a press (not shown) creating a flat that is subsequently stamped or cut into a preformed box flat suitable for assembly into a container. Such a flat may be printed with various indicia, such as a company brand or logo.

The object 24 is transported from the feeder area by the transport assembly 22 on a well-known conveyor. The system 20 also includes a validation station 30 suitably positioned between the applicator station 28 and the collection station 26.

The applicator station 28 generally includes a spool 40 of identification tags, a label applicator 42, and a take-up spool 44. The applicator station 28 is designed to apply identification tags 46 to the object 24 at a high-speed rate and is suitable in high throughput manufacturing systems. One such applicator is a C-100-HS RFID labeler, manufactured and sold by WS Packaging-Automated Systems of 13 Carry Way, Carson City, Nev. 89706. Although a high speed applicator is described, other types of applicators, such as low and medium speed applicators, are also within the scope of the present disclosure.

A plurality of identification tags 46 stored on the spool 40 are fed to the label applicator 42 where at least one identification tag 46 is applied to the object 24. The plurality of identification tags 46 may be sequentially or continuously supplied to the applicator 42. Such identification tags 46 are suitably attached to a transport medium 48, such as tape, which is then received on the take-up spool 44 after passing through the applicator 42. Before the identification tag 46 is applied to the object 24, it passes through at least a portion of the validation station 30.

The validation station 30 includes first and second validators 60 and 62, a sensor measuring device 64, and a marking apparatus 66, all in communication with a data collection and reporting station 68 (“reporting station 68”) by middleware, generally designated by the reference number 70. The reporting station 68 generally includes a programmable logic controller (“PLC”), a central processing unit (“CPU”) 72, and a monitor 74. The PLC is a well-known controller used in conjunction with the applicator 42. Although the PLC is described as being a component of the reporting station 68, it should be apparent that the PLC may be located at other points along the system 20, such as at the location of the applicator 42. It should also be noted that the sequencing of the first and second validators 60 and 62 and sensor measuring device 64 are illustrative and non-limiting. As a result, the sensor measuring device 64 may be located either before or in between the first and second validators 60 and 62 and, therefore, other embodiments are also within the scope of the present disclosure.

The first and second validators 60 and 62 are suitably a low power UHF reader module commonly associated with RFID tags. One such validator is known as an MP9310 low power UHF reader module, sold by SAMsys Technology, Inc., of Durham, N.C. 27713. Although a low power reader is preferred, other types of readers, such as a high powered reader, are also within the scope of the present disclosure.

The first validator 60 is positioned at a suitable location near the applicator station 28, such that information tags 46 are tested to determine whether any given subset of information tags satisfy predetermined operational parameters. Specifically, each identification tag 46 is identified as a “failed” or “non-operational” identification tag if it is non-responsive to an interrogation signal, such as an electronic pulse, emitted by the first validator 60. As such, each identification tag 46 is tested before being applied to the object 24 to determine whether the identification tag 46 is operational or non-operational.

In accordance with certain embodiments of the present disclosure, the first validator 60 may emit a second interrogation signal if the identification tag 46 being tested fails to provide an expected response signal. In such an embodiment, the first validator 60 will emit a first interrogation signal, wait for an appropriate return signal, and if no such return signal is received, the first validator 60 will emit a second interrogation signal.

If a response signal is not returned from the identification tag 46, the spool 40 is advanced to the next information tag 46 on the tape 48. This process is repeatable until a working or operational identification tag 46 is located and validated by the first validator 60. Although it is preferred that the process is repeatable until an operational identification tag is located, other methods, such as eliminating the first validator 60 and applying all tags for subsequent testing, or repeating the process a predetermined number of times, are also within the scope of the present disclosure.

When a working or operational identification tag 46 is identified by the first validator 60, it is applied to the object 24 by the label applicator 42. The applicator 42 applies an identification tag 46 to the object 24 at a speed that substantially matches the speed of objects 24 being transported by the conveyor of the transport assembly 22. The timing of identification tags 46 being applied to the objects 24 is synchronized in any one of well-known methods.

As an example, the transport assembly 22 may include an encoder (not shown) adapted to sense the speed of the conveyor. Such a system may also include a gap sensor (not shown) for measuring distances between objects 24 being transported by the conveyor of the transport assembly 22. The gap sensor and encoder are in operational communication with the PLC in a manner well-known in the art to control activation of the various aspects of the applicator and validation stations 28 and 30. Such a method of synchronization is provided for illustration purposes only and is not intended to be limiting.

As the object 24 is transported along the predetermined path by the transport assembly 22, it moves within range of the second validator 62. Like the first validator 60, the second validator 62 emits an electronic pulse to determine whether the identification tag 46 attached to the object 24 satisfies the predetermined operational parameters. The electronic pulse emitted by the second validator 62 “pings” the identification tag 46 and is adapted to receive a response signal from the identification tag 46. If an expected response signal is not received by the second validator 62, the object 24 is identified as including an identification tag 46 that is non-operational. Such a non-operational identification tag 46 is deemed to be a “failed” tag. If the identification tag 46 is deemed to be non-operational or failed tag, the PLC is notified that the object 24 includes a “bad” tag and the object 24 is identified for marking by the marking apparatus 66 when the object 24 moved within range of the marking apparatus 66.

The second validator 62 may also include an optional capability adapted to collect information embedded on the information tag 46. In the event that the second validator 62 includes such an optional capability, the second validator 62 includes a communication module capable of transmitting any data embedded on the information tag 46 back to the reporting station 68 by the middleware 70.

As a non-limiting example, the PLC sends a “read tag” command to the second validator 62 via a serial port. The second validator 62 responds by emitting the electronic signal and collects the response signal from the information tag 46. The response signal, including any data embedded on the information tag 46, is transmitted by a serial port back to the PLC. This data is stored in an appropriate database and may also be visually displayed at the monitor 74, which is connected to the PLC through the middleware.

Still referring to FIG. 1, the conveyor of the transport assembly 22 continues moving the object 24 along its predetermined path, where it is moved into range of the sensor measuring device 64. The sensor measuring device 64 is suitably a visual detect system, such as a camera. One such camera is known as a Legend 510, manufactured and sold by DVT Machine Vision, a subsidiary of Cognex Corporation of Natick, Mass.

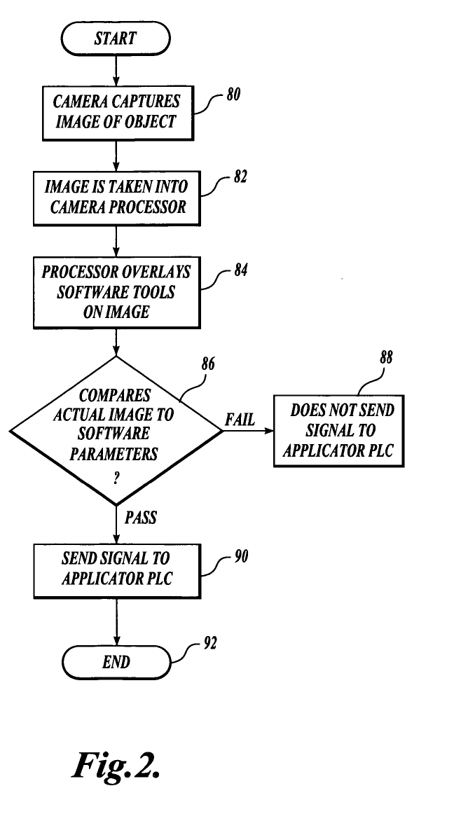

The optional sensor measuring device 64 is integrated into the method of the present disclosure to verify that the location of the identification tag 46 on the object 24 is within predetermined location parameters. A non-limiting example of how the sensor measuring device 64 verifies location parameters may be best understood by referring to FIG. 2.

When the object 24 is moved within range of the sensor measuring device 64, the PLC activates the sensor measuring device 64, indicated by the start block 78. Once activated, the camera captures an image of the object 24, including the identification tag 46, as indicated by the block 80 of FIG. 2. As indicated in block 82, the image is received within a processor of the sensor measuring device 64. The processor overlays software based measuring tools, such as those associated with a software package known as FRAMEWORKS, sold by DVT Machine Vision, a subsidiary of Cognex Corporation of Natick, Mass., on the image for comparison to ensure that the identification tag 46 is located within the predetermined positional parameters stored in the processor. This is indicated in block 84.

As shown in the decision block of 86, the actual image is compared to the positional parameters set forth in the software, and if the actual image is not substantially within the positional parameters, it is deemed to be a “failed” location. In the event that the actual image is not within the positional parameters and, therefore, is deemed a positionally unacceptable information tag, the processor does not send a signal to the PLC, as indicated by the block 88. The signal is not sent to the PLC in the event of an unacceptable information tag as a “fail safe” condition. Specifically, if the PLC does not receive a signal for whatever reason, this is deemed to be an unacceptable condition and the object 24 is queued for marking at the marking station 66.

As used within this detailed description, “substantially within positional parameters” is intended to mean an identification tag 46 that is located within 20% of the expected location defined within the positional parameters of the software. As a non-limiting example, if the dimensions of the identification tag 46 are 4″×⅝″, the identification tag is deemed to be positionally unacceptable if it is located outside of the defined positional parameters by more than ⅛″ of an inch in any direction.

As indicated by the block 90, if the image from the sensor measuring device 64 compares favorably to the predetermined positional parameters, then the location of the identification tag 46 on the object 24 is deemed to be a properly located tag and the database is notified. Specifically, a signal is sent to the PLC indicating that the object 24 includes a properly located identification tag 46. Thus, if the information tag 46 is deemed to be positionally unacceptable, no signal is sent to the PLC and the object 24 is queued for marking by the marking apparatus 66, as described below. The end of the process is indicated by the end block 92.

Referring back to FIG. 1, the object 24 is moved further down the predetermined path on the conveyor of the transport assembly 22. When it reaches the marking apparatus 66, a distinguishing mark may be applied to the object 24. Specifically, if the PLC indicates that the particular object 24 is within the range of the marking apparatus 66 and includes an information tag 46 that is inoperable (or missing), the PLC receives a signal activating the marking apparatus 66 to apply a distinguishing mark, such as UV paint. If the PLC did not receive a signal from the sensor measuring device 64 (indicating an improperly located or missing information tag 46), the marking apparatus 66 applies a distinguishing mark to designate the object 24 for removal at the collection station 26. If, on the other hand, the PLC indicates that the particular object 24 includes an identification tag 46 that is both operational and is properly located, the marking apparatus 66 is not activated, and the object 24 continues along its predetermined path without any distinguishing marking being applied.

The conveyor deposits the object 24 into a bin 100 located at the collection station 26. Thereafter, objects 24, including the distinguishing mark, may be sorted and recycled.

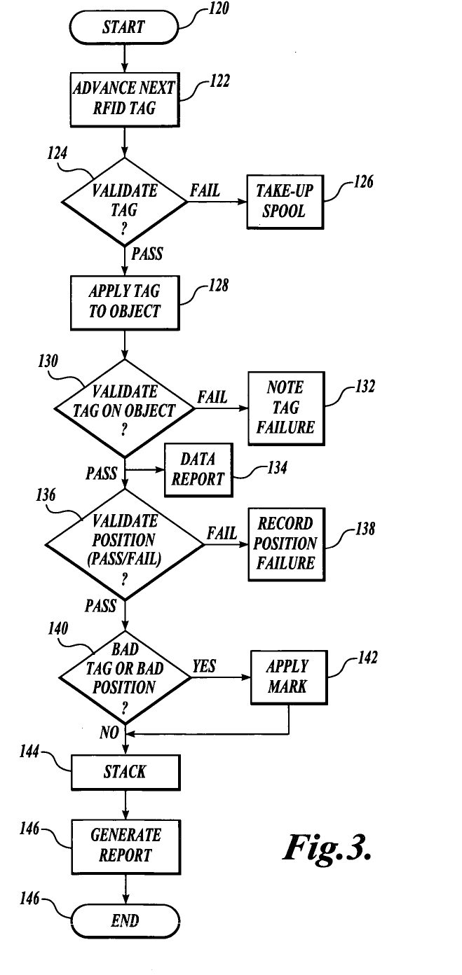

FIG. 3 is a flow diagram illustrating operational aspects of the system of FIG. 1. The beginning of the operational sequence is represented by the start block 120 with the spool 40 of the applicator station 28 advancing an information tag 46, indicated by the block 122. As the information tag 46 passes the first validator 60, the validator 60 emits at least one electronic signal to validate the tag, as indicated by the decisional block 124. As noted above, a second (or more) electronic signal may be emitted by the first validator 60.

If an expected response signal is not received by the first validator 60, the information tag 46 is deemed to be a failed tag and is returned to the take-up spool 44 indicated by the block 126. If the information tag 46 is deemed to be an acceptable tag, the tag is applied to the object by the label applicator 42 and as indicated by the block 128.

As described above with respect to FIG. 1, the conveyor of the transport assembly 22 advances the object 24 having the newly attached information tag 46 and is advanced to the second validator 62. At the second validator 62, a validation signal is emitted to apply a second validation test on the information tag 46. This is indicated by the decisional block 130.

As described above, if the information tag 46 fails to respond to the electronic signals emitted by the second validator 62, it is deemed to be a tag failure and the PLC is notified, as indicated by the block 132. If the tag is an operational or valid tag, information embedded on the tag is relayed back to the PLC, indicated by the block 134, for data reporting, if desired.

The object 24 is then transported along its predetermined path to the sensor measuring device 64, where the position of the information tag 46 on the object 24 is verified. This is depicted by the decision block 136. If the location of the information tag 46 is not substantially within the predefined positional parameters, the PLC is notified that the object 24 includes an unacceptable information tag location, indicated by the block 138. The object 24 is then transported to the marking apparatus 66 by the conveyor of the transport assembly 22.

Still referring to FIG. 3, as the object 24 is moved within range of the marking apparatus 66, the PLC indicates whether the information tag 46 is a non-operational (or missing) information tag or an improperly located tag, indicated by the decision block 140. If the information tag 46 has been indicated as a bad tag or an improperly located tag, the marking apparatus 66 applies a distinguishing mark, which is indicated by the block 142. Thereafter, the object 24 is transported to the bin 100 of the collector station 26, indicated by the block 144.

The operator has the option of generating the report (indicated by the block 146). Such a report includes information such as data embedded upon the information tags, number of tags deemed inoperable or missing by either the first or second validator 60 or 62, as well as the number of improperly placed tags on objects 24. Additional information may be generated and reported, as desired. The end of the process is indicated by the end block 148.

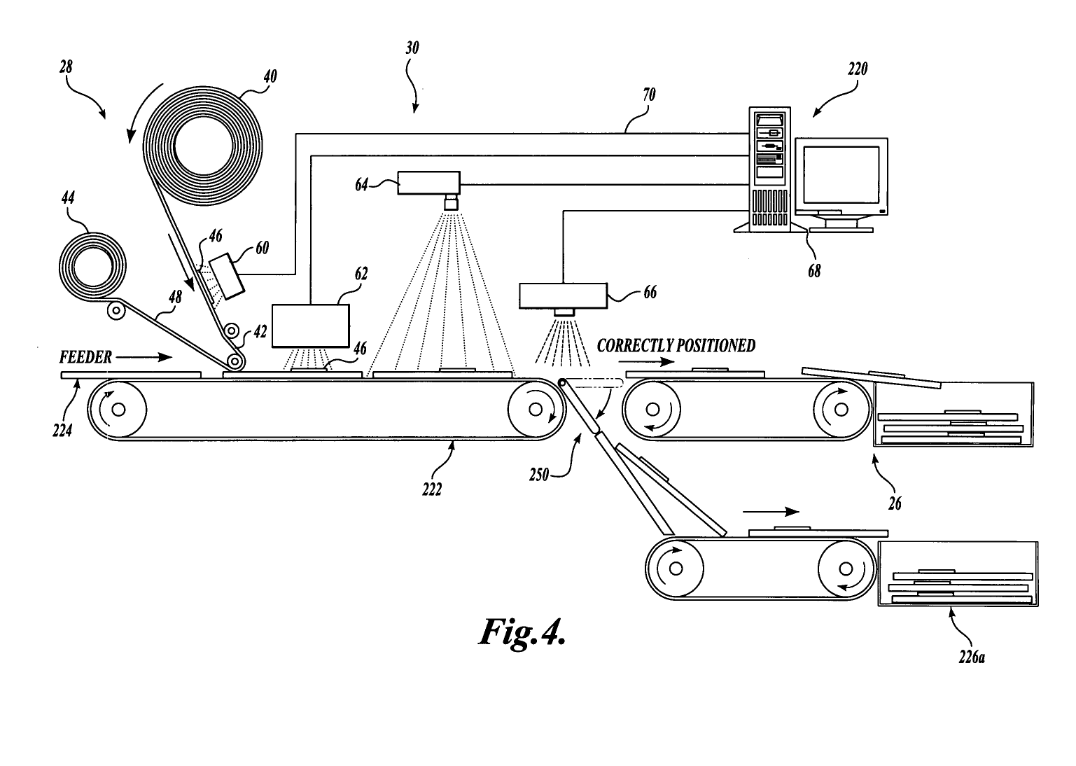

Although the subject matter has been described in language specific to structural features and/or methodological acts, it is to be understood that the subject matter defined in the appended claims is not necessarily limited to the specific features or acts described above. Instead, the specific features and acts described above are disclosed as example forms of implementing the claims. Accordingly, it should be appreciated that various changes can be made therein without departing from the spirit and scope of the disclosure. One such example is best seen by referring to FIG. 4.

FIG. 4 illustrates an alternate system for carrying out the above method and is substantially identical in operation, as described above, with the following exception. Specifically, the system 220 includes a diverter 250. The diverter 250 will automatically divert an object 224 that includes an information tag 246 that is either inoperable or improperly located on the object 224. The object 224 is diverted from the main conveyor of the transport assembly 222 and is stored in a separate collection station 226a. Another alternate embodiment may first apply a distinguishing mark from the marking apparatus 226 before being diverted from the main conveyor by the diverter 250.

Another embodiment within the scope of the present disclosure may be best understood by referring back to FIG. 1. The previously described systems 20 and 220 include a transport assembly 22 that operates at a substantially constant speed. However, the transport assembly 22 and corresponding components of the system 20 may be reconfigured such that the entire operation is done in a stepped fashion, as opposed to operating at a uniform rate.

As an example, the transport assembly 22 may operate such that the object 24 is moved in a stepped or sequential fashion, stopping at various stations, such as stopping at the applicator station 28 and each subsequent station along the predetermined path defined by the transport assembly 22. Thus, the method of the present disclosure may be implemented in a variety of systems and, therefore, the system for implementing the method is provided for illustration purposes only and is not intended to be limiting.

1. In an assembly line of the type having a conveyor for moving an object along a predetermined path, a method of applying an identification tag to the object, the method comprising:
(a) using the conveyor for automatically advancing the object along the predetermined path;
(b) supplying a plurality of identification tags;
(c) testing the plurality of identification tags to identify at least one operating identification tag; and
(d) applying at least one operating identification tag on the object while the object is on the conveyor.

2. The method of claim 1, further comprising advancing the plurality of identification tags until the at least one operating tag is identified.

3. The method of claim 1, further comprising testing the at least one operating identification tag to determine whether the at least one identification tag satisfies predetermined operational parameters.

4. The method of claim 3, further comprising identifying the at least one operating identification tag as a failed identification tag if the at least one operating identification tag does not satisfy the predetermined operational parameters.

5. The method of claim 3, further comprising reading and storing data embedded on the at least one operating identification tag.

6. The method claim 1, further comprising obtaining a location of the at least one operating identification tag on the object.

7. The method of claim 6, wherein obtaining a location of the at least one operating identification tag on the object includes a sensor measuring device positioned for recording the location of the at least one operating identification tag.

8. The method of claim 7, wherein the sensor measuring device is a camera.

9. The method of claim 3, further comprising obtaining a location of the at least one operating identification tag on the object.

10. The method of claim 9, further comprising comparing location of the at least one operating identification tag to determine whether the location of the at least one operating identification tag satisfies predetermined positional parameters.

11. The method of claim 10, further comprising identifying the at least one operating identification tag as a failed identification tag if the at least one operating identification tag does not satisfy the predetermined positional parameters.

12. The method of claim 11, further comprising identifying objects having a failed identification tag.

13. In an assembly line of the type having a conveyor for moving an object in a predetermined path, a method of applying an identification tag to the object, the method comprising:
(a) using the conveyor for automatically advancing the object along the predetermined path;
(b) supplying a plurality of identification tags;
(c) testing the plurality of identification tags one identification tag at a time to distinguish between operational and nonoperational identification tags;
(d) applying at least one operational identification tag at a predetermined location on the object; and
(e) rejecting the object if the at least one operational identification tag is not substantially within the predetermined location.

14. The method of claim 13, wherein testing a plurality of identification tags includes applying an electronic signal to one of the plurality of identification tags to determine whether the one of the plurality of identification tags is operational or nonoperational.

15. The method of claim 14, further comprising applying a second electronic signal if the one of the plurality of identification tags is nonoperational.

16. The method of claim 13, further comprising testing the at least one operational identification tag after the at least one operational identification tag is applied to the object.

17. The method of claim 16, further comprising reading data embedded on the at the least one operational identification tag.

18. In an assembly line of the type having a conveyor for moving an object in a predetermined path, a method of applying an identification tag to the object, the method comprising:
(a) using the conveyor for automatically advancing the object along the predetermined path;
(b) automatically applying at least one identification tag to the object;
(c) testing the at least one identification tag on the object to determine whether the at least one identification tag is an operating or nonoperating identification tag;
(d) verifying that the location of the at least one identification on the object is substantially within predetermined location parameters; and
(e) distinguishing objects having either nonoperating identification tags or objects having identification tags located substantially outside of the predetermined location parameters.

19. The method of claim 18, further comprising testing the plurality of identification tags before the at least one identification tag is applied to the object to determine whether the at least one identification tag is an operational or nonoperational identification tag.

20. The method of claim 19, further comprising advancing the plurality of identification tags before the at least one identification tag is applied to the object if the at least one identification tag is determined to be a nonoperational identification tag.
